(19) United States
(12) Patent Application Publication
(10) Pub. No.: US 2013/0262365 A1
(43) Pub. Date: Oct. 3, 2013

(54) EDUCATIONAL SYSTEM, METHOD AND PROGRAM TO ADAPT LEARNING CONTENT BASED ON PREDICTED USER REACTION

(71) Applicants: Catherine Mary DOLBEAR, Oxford (GB); Philip Glenny EDMONDS, Oxford (GB)

(72) Inventors: Catherine Mary DOLBEAR, Oxford (GB); Philip Glenny EDMONDS, Oxford (GB)

(73) Assignee: SHARP KABUSHIKI KAISHA, Osaka (JP)

(21) Appl. No.: 13/436,840

(22) Filed: Mar. 31, 2012

(51) Int. Cl. G06N 5/02

(52) U.S. Cl. 706/47; 706/50

(57) ABSTRACT

An educational system that includes a content item selector configured to select at least one content item from a database so that the reaction of the user required by the at least one content item matches according to a predetermined criteria a prediction of how the user will react to the type of user reaction required by the at least one content item; and a content item output which presents the selected at least one content item to the user.

### TECHNICAL FIELD

The invention relates to an educational system which adapts its learning content to a user. Further, the invention relates to a method of adapting such learning content based on predicted user reaction. Embodiments are applicable to learning any subject or skill, but are especially useful in language learning.

### BACKGROUND ART

Education outside of a traditional classroom setting is becoming more popular, as such self-study or “informal” learning can be cheaper to deliver and tailored more to the individual learner's needs and educational requirements. It can also fit in to the learner's daily life more easily, as study sessions do not have to be as long as a traditional school class and can take place anywhere or at any time. Furthermore, the plethora of computing devices now available to the learner, such as smart phones, tablets, internet-enabled televisions, as well as personal computers, allow interactive multimedia content to be presented to the learner in a variety of contexts, both in a static location such as the home or workplace, and whilst mobile.

However, this informal ubiquitous learning presents problems for learners which are not encountered in the traditional classroom setting. Firstly, without a teacher present, or regular class attendance, it can be more difficult for the learner to motivate themselves to continue to study over time. This means that time between study sessions can be longer. For example, in D. Corlett, M. Sharples, S. Bull and T Chan “Evaluation of a mobile learning organizer for university students” published in the Journal of Computer Assisted Learning 21, pp 162-170 by Blackwell Publishing Ltd 2005, after ten months of use, only 40% of participants were studying twice a week or more.

A wide variety of educational content is now available, including videos, audio lessons, quiz questions, reading exercises, writing activities and interactive exercises such as conversation practice with a virtual partner. Many of these content items comprise more than one medium, and they require a variety of physical, affective or cognitive responses from the learner. For example, the learner may need to concentrate hard to understand a complex point, or read a long passage of information, or may need to speak out loud in order to practice a foreign language pronunciation or take part in a conversation with a virtual conversation partner. Therefore a second problem for the learner occurs if the setting in which the learner is studying is inappropriate for the required response. For example if the location is too noisy or busy for effective concentration, if listening or writing is physically difficult, or if the location is too public for the learner to feel comfortable in carrying out the learning task (for example pronunciation practice of a foreign language).

A study, “Diversity in Smartphone Usage” by H. Falaki, R. Mahajan, S. Kandula, D. Lymberopoulos, R. Govindan and D. Estrin, MobiSys '10 Jun. 15-18 2010, San Francisco, Calif. published by ACM 2010, of smartphone users has shown that the mean interaction length of different users using a smartphone is 10-250 seconds. Applying this result to learning, a third difficulty for a learner's interaction with learning content when outside of the classroom is that study sessions are likely to be much shorter than in the classroom. Furthermore, the same study highlighted the diversity of smartphone users' session lengths and session frequency of at least one order of magnitude. Such a broad spread of usage patterns indicates a strong need for adaptation to the individual user.

The problem that this invention addresses therefore is how to select learning content that is appropriate for an individual learner's study in a particular context of use. It particularly addresses the problem where the content requires a certain response from the learner. By presenting appropriate material to the individual learner, study efficiency increases, and hence motivation may increase as the learner achieves greater progress.

It is well-known in the prior art how to modularize learning content into individual content items and tag or mark them up with information so that they can be presented to a learner on their personal device in a pedagogically appropriate sequence. Systems exist, for example [US 2009/0162828 A1 (Strachan et al., published 29 Jun. 2009)], that allow an instructional designer or teacher to manually specify the sequence of content to be presented to the learner. However, the best way to automatically select the sequence or adapt the content item to the learner is still an open question.

A variety of devices and computer systems have been developed to address the problem of automating this process and automatically adapting learning content to a mobile learner. Content is adapted based on one or more of a content model, a context model or a user model.

There are several well-known methods for obtaining a content model by extracting semantic meaning from multimedia content. For example natural language processing techniques can be used to extract keywords from text that is either directly part of the content, or has been converted from audio using a speech-to-text engine or parsed from video captions [U.S. Pat. No. 7,606,799B2 (Kalinichenko et al., published 20 Oct. 2009)]. These content models are then used in a relevancy function, to determine the highest priority content item for the user.

Context can be modeled in order to adapt the content to the location and situation of the learner. The user's location can be measured by GPS coupled with map data, or inferred from their calendar appointments and time of day, or simply by asking the user explicitly where they are [Context and learner modeling for the mobile foreign language learner, Y. Cui and S. Bull, System 33 (2005) pp 353-367 Elsevier]. Similarly, other parameters such as the amount of time the user has available, concentration level or frequency of interruptions can also be included in the context model and either implicitly estimated or explicitly requested from the user. However, Cui and Bull do not address the need to tailor their context-based adaptation to different users whose reaction may change over time, or deviate from a default. There is still a need for a system where the reaction of the users is monitored and adapted to over time.

The capabilities of the device can also be included in the context model, for example U.S. Pat. No. 7,873,588B2 (Sareday et al., published 18 Jan. 2011) describes a method and apparatus for an educator to author learning content items tailored to specific devices by combining content in a learning management system. In U.S. Pat. No. 7,873,588B2, the content items selected for the device are not adapted to the individual user however, but only to the device.

Adaptive computer-based teaching systems that model user knowledge are known as Intelligent Tutoring Systems or Instructional Expert Systems. The general structure of such systems is well known in the prior art [e.g., U.S. Pat. No. 5,597,312 A (Bloom et al., published 28 Jan. 1997)], including steps such as presenting one or more exercises to the user, tracking a user's performance in a user model, making inferences about strengths and weaknesses of a learner using an inference engine and an instructional model, and adapting the system's responses by choosing one or more appropriate exercises to present next according to an instructional model. Some include the usage history as part of the user model [WO2009058344A1 (Heffernan, published 7 May 2009)], while others [U.S. Pat. No. 7,052,277 B2 (Kellman, published 30 May 2006)] monitor the student's speed and accuracy of response in answering a series of tasks, and modify the sequencing of the items presented as a function of these variables. One parameter that can be included in the user model, which is derived from the usage history, is the user's current knowledge of a learning item. For example, this can be inferred from responses to activities about that item. These methods do not address the present problem however, because they do not take into account the case where the user fails to respond in a way that the system deems “correct”, not because they do not know the answer, but because their context prevents them from answering. There is still a need for a system which only shows content in a context where the user feels able to provide an answer when they know it.

There has been some input to the problem from the inclusive design community, [Rich Media Content Adaptation in E-learning systems, S. Mirri, Universita di Bologna, PhD thesis 2007], where the learner's disabilities are included in their user model, and content is transcoded appropriately. However, since the system was targeted at people with disabilities that are a constant and do not change over time, the approach does not address the issue of when a learner's reactions change according to context, or change over time, and this approach does not address the need to learn and adapt to this change.

In summary, none of these prior art systems provide an effective contextualized learning system for the ubiquitous environment where there is a need for a user to be able to respond to the content item in the way that the content item requires for most effective learning. No system adapts to different users' history of reactions to different types of content in different contexts.

### SUMMARY OF INVENTION

A technical problem with the prior art is that none addresses the need to provide a learner with personalised learning content that they can respond to appropriately, given the context in which they find themselves, and the need to adapt to the learner's changing behaviour over time.

According to an aspect of the invention, an educational system is provided that includes a database which stores a set of distinct multimedia learning content items and content item semantics which identify a reaction of a user required by a corresponding content item in the set of content items; a digital processor which includes: a user context determination component configured to determine a context in which the user is using the system; a user reaction storage configured to store a history of previous reactions of the user to content items within the set of content items and the contexts in which the user interacted with the content items; a user reaction prediction component configured to predict how the user will react with respect to different types of user reactions required by the content items based on the context determined by the user context determination component and on the history of previous user reactions to the content items and the contexts in which the user interacted with the content items stored in the user reaction storage; and a content item selector configured to select at least one content item from the database so that the reaction of the user required by the at least one content item matches according to a predetermined criteria the prediction of how the user will react to the type of user reaction required by the at least one content item; and a content item output which presents the selected at least one content item to the user.

According to another aspect, the set of content item semantics include an expected consumption time of the corresponding content item for a default user; the user reaction prediction component is configured to predict a consumption time of the corresponding content item for the user; and the content item selector is configured to select the at least one content item based on the expected consumption time and the predicted consumption time.

In accordance with another aspect, the digital processor including a user knowledge storage component which stores a user knowledge model representing a degree to which the user knows pedagogical concepts in the set of content items, and wherein the content item selector is configured to select the at least one content item based on the user knowledge model.

According to still another aspect, the digital processor further including a user knowledge update component configured to update the user knowledge model based on user reactions to content items within the set of content items which have been presented to the user.

In yet another aspect, the user knowledge update component is configured to update the user knowledge model based on a time duration of reactions of the user to content items within the set of content items which have been presented to the user.

According to still another aspect, the user knowledge update component is configured to update the user knowledge model based on at least one of a sufficiency and correctness of reactions of the user to content items within the set of content items which have been presented to the user.

In accordance with another aspect, the digital processor further including a user interaction monitor configured to monitor interactions of the user with the selected at least one content item presented to the user.

According to another aspect, the digital processor further including a user reaction extraction component configured to extract the user reaction to the at least one content item presented to the user from the interactions monitored by the user interaction monitor.

In still another aspect, the user reaction extraction component comprises a rulebase including rules which are applied to interactions monitored by the user interaction monitor, and user reactions are extracted based on whether the rules are satisfied.

According to another aspect, the extracted user reaction is used to update the history stored in the user reaction storage.

In accordance with another aspect, a context of the user determined by the user context determination component includes a location of the user insofar as a type of place where the user is located.

According to still another aspect, a context of the user determined by the user context determination component includes an amount of study time available to the user.

In accordance with another aspect, a context of the user determined by the user context determination component includes capabilities of a user device included in the system.

In still another aspect, the content item selector is configured to identify a next content item in accordance with a course structure stored in the database.

According to another aspect, the user reaction prediction component is configured to predict how the user will react to a given content item by fetching the content item semantics corresponding to the given content item, fetching a current context of the user as determined by the user context determination component, fetching previous user reactions to contexts similar to the current context from the user reaction storage, identifying the required user reaction to the given content item from the corresponding content item semantics, and determining the probability of the user making the required user reaction to the given content item based on the previous user reactions to contexts similar to the current context.

According to another aspect, in the event there is an insufficient number of previous user reactions available from the user reaction storage, the user reaction prediction component is configured to at least one of (i) use pre-determined probability values to determine the probability of the user making the required user reaction; and (ii) use the pre-determined probability values in combination with the previous user reactions available from the user reaction storage.

In accordance with another aspect, the different types of user reactions required by the set of content items include two or more of pronunciation, reading, concentration, listening, remembering, response to quiz, writing and watching.

According to another aspect, the educational system is embodied within at least one of a smart phone, tablet, personal computer, notebook computer, television, interactive whiteboard.

In accordance with another aspect, a method to adapt learning content based on predicted user reaction is provided which includes: providing a database which stores a set of distinct multimedia learning content items and content item semantics which identify a reaction of a user required by a corresponding content item in the set of content items; utilizing a digital processor to provide: a user context determination component configured to determine a context in which the user is using the system; a user reaction storage configured to store a history of previous reactions of the user to content items within the set of content items and the contexts in which the user interacted with the content items; a user reaction prediction component configured to predict how the user will react with respect to different types of user reactions required by the content items based on the context determined by the user context determination component and on the history of previous user reactions to the content items and the contexts in which the user interacted with the content items stored in the user reaction storage; and a content item selector configured to select at least one content item from the database so that the reaction of the user required by the at least one content item matches according to a predetermined criteria the prediction of how the user will react to the type of user reaction required by the at least one content item; and presenting the selected at least one content item to the user.

In accordance with still another aspect, a non-transitory computer readable medium is provided having stored thereon a program which when executed by a digital processor in relation to a database which stores a set of distinct multimedia learning content items and content item semantics which identify a reaction of a user required by a corresponding content item in the set of content items, carries out the process of: determining a context in which the user is using the system; storing a history of previous reactions of the user to content items within the set of content items and the contexts in which the user interacted with the content items; predicting how the user will react with respect to different types of user reactions required by the content items based on the determined context and on the stored history of previous user reactions to the content items and the contexts in which the user interacted with the content items; selecting at least one content item from the database so that the reaction of the user required by the at least one content item matches according to a predetermined criteria the prediction of how the user will react to the type of user reaction required by the at least one content item; and presenting the selected at least one content item to the user.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 is a block diagram of a system to select a learning content item in accordance with an exemplary embodiment of the present invention;

FIG. 2 is a flowchart of a method to adapt learning content in accordance with an exemplary embodiment of the present invention;

FIG. 3 is a flowchart of a decision making process for selecting a learning content item in accordance with an exemplary embodiment of the present invention;

FIG. 4 is a flowchart of a decision making process for predicting if the user can complete a learning content item in the user's available time in accordance with an exemplary embodiment of the present invention;

FIG. 5 is a flowchart of a decision making process for selecting a learning content item including a user knowledge model in accordance with an exemplary embodiment of the present invention;

FIG. 6 is a flowchart of a decision making process for extracting a set of user reactions from a set of user interactions in accordance with an exemplary embodiment of the present invention;

FIG. 7 is a table of a rulebase used to extract a set of user reactions from a set of user interactions in accordance with an exemplary embodiment of the present invention;

FIG. 8 is a flowchart of a decision making process for predicting user reaction to a content item in accordance with an exemplary embodiment of the present invention;

FIG. 9 is a flowchart of a decision making process for updating user knowledge in accordance with an exemplary embodiment of the present invention;

FIG. 10 is a front view of a device and content item in accordance with an exemplary embodiment of the present invention;

FIG. 11 is a front view of a device and content item in accordance with an exemplary embodiment of the present invention;

FIG. 12 is an embodiment of a content item semantics extraction system in accordance with the present invention; and

FIG. 13 is an embodiment of a graph structure of content items and content item semantics in accordance with the present invention.

### DESCRIPTION OF REFERENCE NUMERALS

100 Set of content items
102 Set of content item semantics
104 Course structure
106 Database
108 Digital processor
109 Microprocessor
110 Learning content adaptation module
112 User context determination component
114 Content item selector
116 Content item output
118 Device
120 User
122 User interaction monitor
124 User reaction extraction component
126 User reaction storage
128 User reaction prediction component
130 User knowledge update component
132 User knowledge storage
134 Memory
200 Activate
202 Determine user context
204 Store user context
206 Predict user reaction
208 Select content item
210 Output content item to user
212 Monitor user interactions
214 Extract user reaction
216 Store user reaction
218 Update user knowledge
220 Store user knowledge
222 Deactivate
300 Fetch user ID
302 Fetch ID of most recently studied content item
304 Determine ID of next content item
306 Retrieve required user reaction for content item
308 Retrieve predicted user reaction for content item
310 Decision point
312 Return selected content item ID
400 Retrieve expected consumption time of content item
402 Calculate user consumption time weighting
404 Calculate predicted user consumption time
406 Retrieve user's available time
408 Return
500 Retrieve content item's pedagogical concepts
502 Decision point
600 Activate
602 Select next rule in rulebase
604 Decision point
606 Add rule consequent to set of user reactions
608 Decision point
610 Output set of user reactions
612 Deactivate
700 Table of a rulebase
710 Rule
720 Antecedent
730 Consequent user reaction
800 Activate
802 Fetch content item semantics
804 Fetch current context
806 Fetch set of previous user reactions to context similar to current context
808 Identify the set of require user reactions in the content item semantics
810 Select next required user reaction
812 Calculate probability
814 Decision point
816 Output set of required user reactions and corresponding probabilities
818 Deactivate
900 Activate
902 Fetch set of user reactions
904 Select next pedagogical concept from content item semantics
906 Select next user reaction from the set of user reactions
908 Fetch user knowledge of the pedagogical concept
910 Update user knowledge of the pedagogical concept
912 Decision point
914 Decision point
916 Output updated user knowledge
918 Deactivate
1000 Content item
1010 Detailed text
1020 Record button
1030 Audio Playback button
1040 Next button
1100 Content item
1110 Simple text
1120 Simple input
1200 Digital processor
1202 Memory
1210 Content item semantics extraction module
1220 Required user reaction extraction component
1230 Pedagogical concepts extraction component
1240 Expected consumption time extraction component
1300 Content item node
1310 Content item node properties
1320 Link to content item semantics
1330 Content item semantics node
1340 Content item semantics node properties
1350 Course structure link
1360 Content item node

### DETAILED DESCRIPTION OF INVENTION

The invention is an adaptive educational system that provides a solution to the problem by including a model of the user reaction that is required by a learning content item, and predicting how a learner will actually react to the content in a given context. The context can include various parameters, for example the user's location and the time they have available, among others. Each particular user will be different. Given a user of the system, the invention will make a prediction about how they will react to the content in a given context, and how long they will react for, based on their history of previous interactions with other content items, in order to determine whether to select the content item for presentation to the user. The term “user reaction” refers to the type of response, for example physical, cognitive or affective among others, that the user will need to make to the system in order to interact appropriately with the content and learn the pedagogical concepts contained therein. For example, to speak, write, or concentrate hard on the learning content items.

An embodiment of the present invention provides an adaptive system for learning. The system works while the user is studying a set of multimedia learning content items, such as a language learning course, using a mobile device. The system includes in the general sense: 1) a database storing each learning content item in the course and a metadata description of each content item's semantics, 2) a component to determine the context in which the user is using the system, 3) a component to monitor the user's interactions with the system 4) a component to predict the type and length of the user's reaction, and 5) a component to select the appropriate content item based on the user's context, predicted type and length of user reaction, and content item semantics. Thus the system can select a learning content item that requires a certain cognitive or physical reaction from a user that fits the context that they are in, including how they previously reacted to similar items. Furthermore, the system will adapt over time if the user changes their reaction in a particular context.

In one example, a learning content item contains a long text to teach a particular pedagogical concept such as a complex grammar concept, which demands high concentration from the user. One of the content item semantics is the pedagogical concept that is being taught by the content item, and this can be retrieved from a database or optionally automatically extracted from the content item. An average or default user requires a quiet study location in order to achieve the required level of concentration, and takes an estimated fifteen minutes' study time to complete the learning content item. However, the current user has previously completed learning content items 50% faster than the average, and has previously successfully mastered content that requires high concentration in noisy, public locations. The adaptive educational system therefore selects the learning content item for the current user to study, even though the current user's context is that they only have ten minutes available for study, and are studying in a noisy location, as the adaptive educational system predicts, based on prior interactions, that the current user will be able to complete the learning content item in the available study time, and also be able to demonstrate the required user reaction, namely concentration, for the learning content item.

The adaptive educational system can be implemented on a device such as a smart phone, tablet, television, interactive whiteboard, in a software program implemented on a personal or notebook computer, in a Web-based server accessed by a computer device, among others.

The adaptive educational system can be applied to other domains, subjects, disciplines, and skills, such as mathematics, natural sciences, social sciences, music, art, geography, history, culture, technology, business, economics, and a variety of training scenarios, not limited by this list.

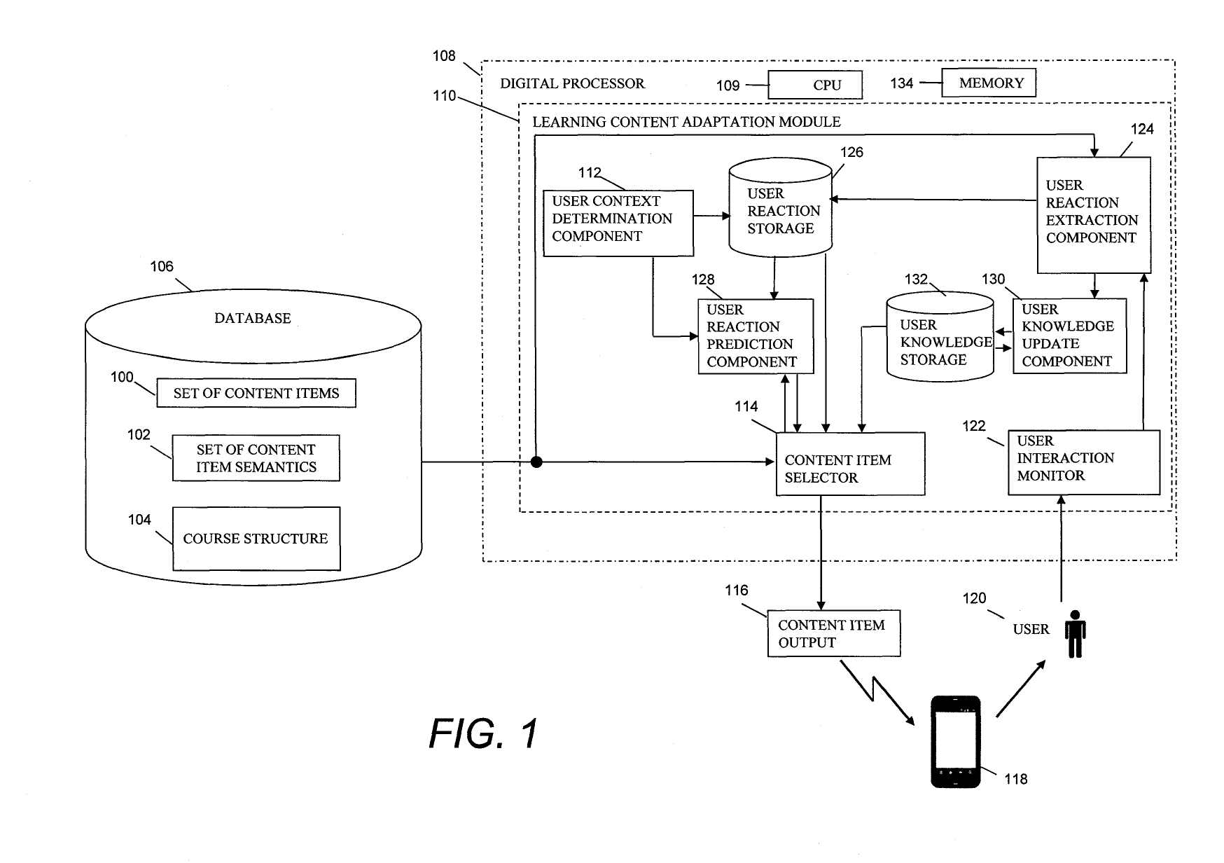

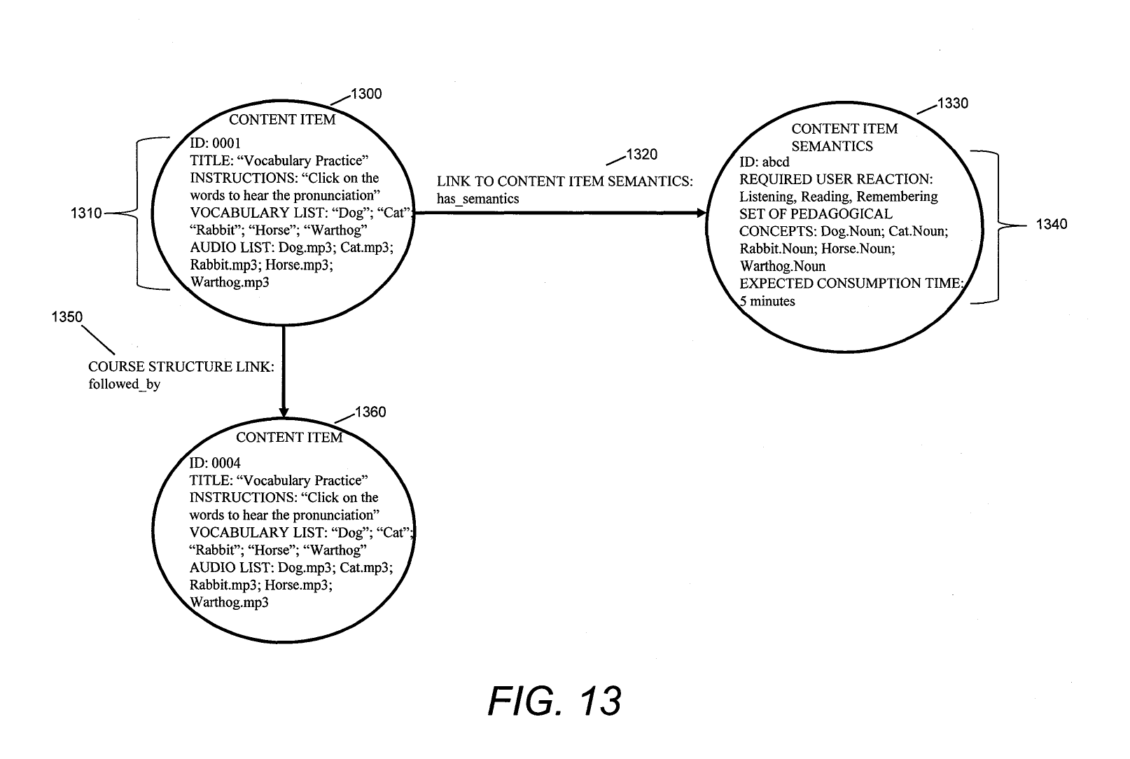

FIG. 1 is a block diagram of an exemplary embodiment of a system to select a learning content item in accordance with the present invention. A set of distinct multimedia content items 100 and a set of content item semantics 102 are stored in a database 106. The database 106 is represented by data stored in any of a variety of conventional types of digital memory including, for example, hard disk, solid state, optical disk, etc. A content item in the set of content items 100 may include one or more multimedia content items such as a video, audio clip or piece of text, organised in such a way as to teach one or more pedagogical concepts. For example, the content item may be organised as one or more of a video comprehension, a quiz, a reading exercise, a speaking practice, a listening exercise, a writing exercise or a grammar lesson, among others. The content item may include a corresponding content item identification (ID) to facilitate access to the content items as discussed below. The set of content items 100 can be stored in the database 106 as a graph structure where each node represents one content item. An exemplary embodiment of a graph structure which can be stored in the database 106 is shown in FIG. 13 and described below.

The set of content item semantics 102 includes information about the set of content items 100. The set of content item semantics 102 includes at least a user reaction required by a corresponding content item in the set of content items 100. Optionally, the set of content item semantics 102 may contain one or more of a set of pedagogical concepts that are being taught by the content item, or the expected consumption time of the content item for a default user.

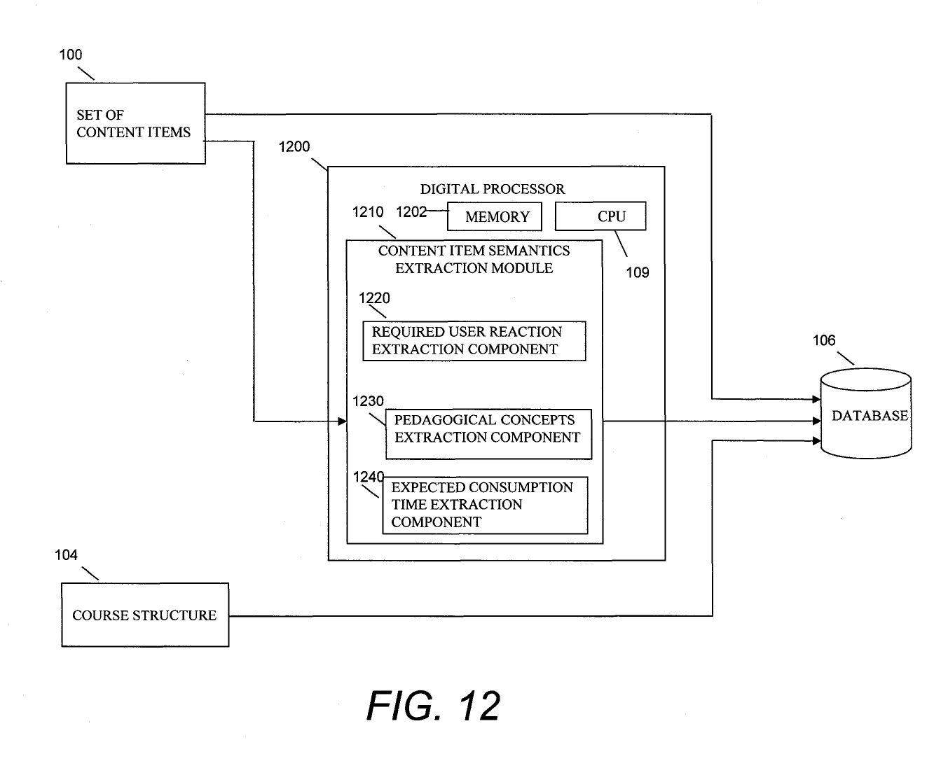

The set of content item semantics 102 may be extracted manually by an operator or content developer, but a preferred embodiment is for the system to automatically extract the set of content item semantics 102 from a set of content items 100, as shown in FIG. 12, described below. The content item semantics 102 can be stored in the database 106 in a graph structure where each node represents the content item semantics corresponding to one content item from the set of content items 100. A preferred embodiment of a graph structure which can be stored in the database 106 is shown in FIG. 13 and described below. Each node in the graph of content item semantics 102 includes at least one or more properties representing required user reaction. Optionally, each node in the graph of content item semantics 102 may contain one or more pedagogical concepts that are taught in the content item. Optionally, each node in the graph of content item semantics 102 may have a property containing the expected consumption time for the content item. The expected consumption time is the length of time that a default or average user is expected to take to work through the learning content in the content item.

Optionally, if the set of content items 100 are related to each other, the relationships between the set of content items 100 are described in a course structure 104 which is stored in the database 106. The preferred embodiment of the course structure 104 is a set of chronological and/or prerequisite pedagogical relationships between the set of content items 100, which is represented as relationship links, such as “followed by” or “has prerequisite”, between the content item nodes in the graph representing the set of content items 100, as shown in FIG. 13 and described below. Depending on the course, the order can be linear or may be based on a tree structure and have multiple branches. The order may be partially or fully described. Including this information in the system has the advantage that the set of content items selected for the user can be comprehended as a logical, coherent sequence as the content items are presented in a sensible order.

A learning content adaptation module 110 is stored in conjunction with a digital processor 108. The digital processor 108 can be the same digital processor as digital processor 1200 discussed below (FIG. 12), or a separate digital processor and the digital processor 108 can reside on a server or on a device 118. A “digital processor”, as referred to herein, may be made up of a single processor or multiple processors configured amongst each other to perform the described functions. The single processor or multiple processors may be contained within a single device or distributed among multiple devices via a network or the like. Each processor includes at least one microprocessor 109 capable of executing a program stored on a machine readable medium. The learning content adaptation module 110 is made up of a user context determination component 112, a content item selector 114, a user interaction monitor 122, a user reaction extraction component 124, user reaction storage 126 and a user reaction prediction component 128. Optionally the digital learning content adaptation module 110 can also contain a user knowledge update component 130 and user knowledge storage 132. Each of these modules and components as described herein may be implemented via hardware, software, firmware, or any combination thereof. The digital processor 108 may execute a program stored in non-transitory machine readable memory 134, which may include read-only-memory (ROM), random-access-memory (RAM), hard disk, solid-state disk, optical drive, etc. The program, when executed by the digital processor 108, causes the digital processor in conjunction with the remaining hardware, software, firmware, etc. within the system to carry out the various functions described herein. The same memory 134 may also serve to store the various data describe herein. One having ordinary skill in the art of programming would readily be enabled to write such a program based on the description provided herein. Thus, further detail as to particular programming code has been omitted for sake of brevity.

The user context determination component 112 determines a user's context, the user's context including at least the user's location. The “location of the user” as defined herein refers to the type of place where the user is located, for example in a noisy or busy location such as on a train, in a shopping mall or restaurant; or in a quiet location such as in a library, café, home or remote location in a natural setting, for example, rather than simply a geo-located co-ordinate position. Optionally, the amount of study time available to the user may be determined and included in the user context (for example, the time available to the user during a commute on a train). Optionally, the capabilities of the user's device can be included in the user context. The capabilities of the user's device and/or the user's device can change over time.

The user context determination component 112 can determine the user's location in a number of ways, including prompting the user to input their location explicitly, or deriving the user's location from map data identifying places of different type coupled with information from the Global Positioning System on the device 118. Optionally, the user context determination component 112 can determine the amount of study time available to the user in a number of ways, including prompting the user to input the amount of study time available to the user explicitly, or deriving the amount of study time from the user's calendar and previous usage history as stored in the user reaction storage 126. After each content item output 116 is presented to the user 120, the amount of study time available is decremented by the length of time that the user has spent studying the content item 116, as recorded by the user interaction monitor 122 and stored in the user reaction storage 126.

Optionally, the user context determination component 112 can determine the capabilities of the user's device 118 in a number of ways, including prompting the user or deriving them from a device profile stored on the device 118 or in the network. The device capabilities can include the device type (for example, smartphone, tablet, television, interactive whiteboard), the screen size and resolution, whether there is a keyboard, whether there is a speaker to output audio, whether there is a microphone for speech input.

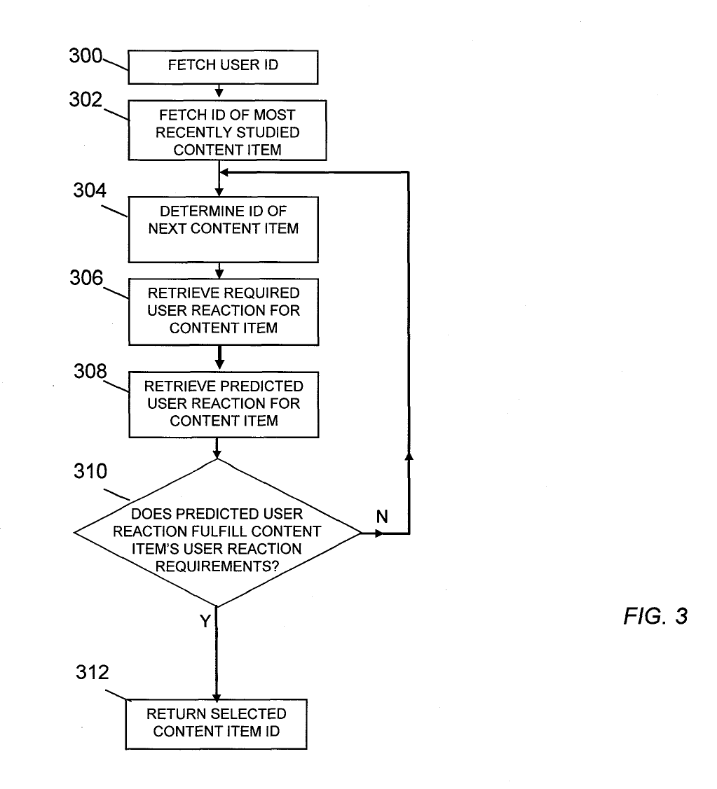

The content item selector 114 selects the most appropriate content item from the set of content items 100 to output to the content item output 116. A flowchart of a decision making process for the selection of the most appropriate learning content item is shown in FIG. 3, and explained later. The content item selector 114 uses information from the database 106 and the predicted reaction of the user to each possible content item from the user reaction prediction component 128 in order to make the decision of which is the most appropriate content item from the set of content items 100 to output. Optionally, the user knowledge from the user knowledge storage 132 is also used by the content item selector 114. The content item output 116 is presented to the user via a display on a device 118, for example. In addition, or in the alternative, the content may be presented to the user in some other corresponding multimedia manner, for example as an audio clip reproduced via the device 118. The device 118 can be any computing device either fixed or portable such as a smart phone, tablet, personal/notebook computer, television, interactive whiteboard, etc., and different devices may be used by the same user 120 at different times during the user's interaction with the system.

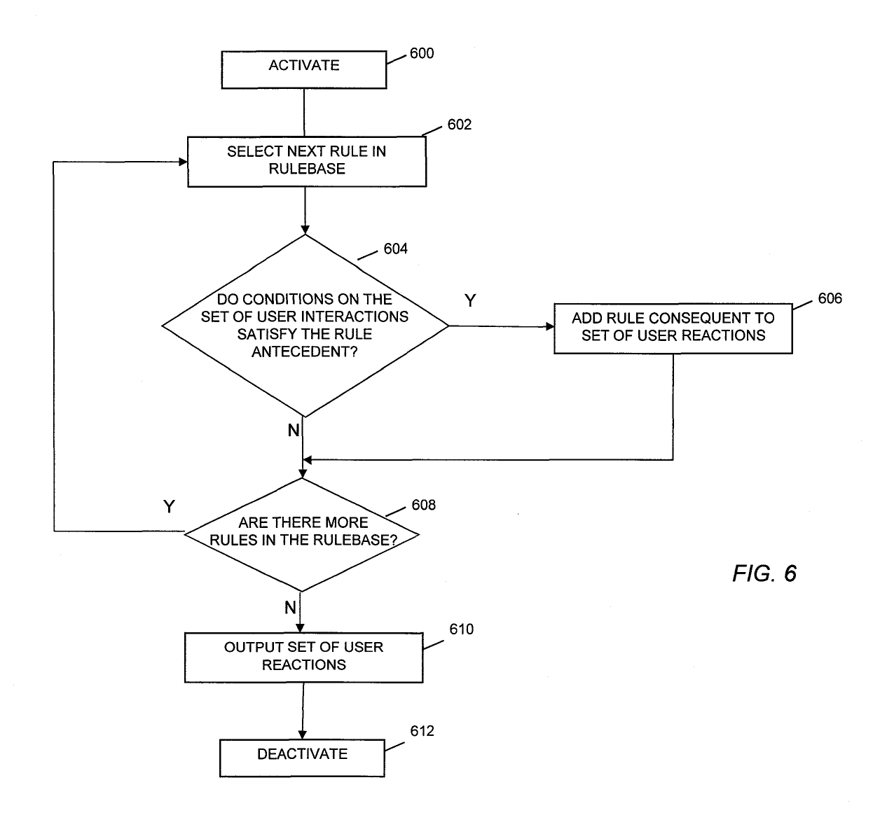

The user 120 interacts with the content item output 116 as displayed on the device 118, and the user interaction monitor 122 records the user's interactions with the content item output. The user interactions may include a list of touch actions such as buttons clicked, swipes or other gestures made by the user 120; the time at which the touch actions are made and the data input to the device 118 by the user 120, such as by voice recording, answered quiz questions; written correct or incorrect text. The user reaction extraction component 124 extracts the user reactions from the user interactions using the content item semantics 102 as a guide. For example, if the content item output 116 has corresponding content item semantics including a requirement that the user should practice pronunciation, and a group of user interactions monitored by the user interaction monitor 122 are that a record button is clicked at time t=n, a stop button is clicked at time t=m, and an audio file is recorded on to the device 118, then the user reaction can be determined to be that the user has recorded their voice for t=m−n seconds, starting at time t=n and finishing at time t=m. An exemplary method for extracting user reaction using a rulebase is shown in the flowchart of FIG. 6, described below, however alternative methods using other known techniques could equally be used.

A history of user reactions extracted by the user reaction extraction component 124 is stored and updated in the user reaction storage 126, along with the corresponding context in which that content item was studied, as determined by the user context determination component 112. In an embodiment for a language learning application, the user reactions to the content may be for example whether the user has recorded their voice on the device in response to a pronunciation practice or read through a long passage of text; clicked on an audio clip to listen; answered quiz questions; written correct or incorrect text or watched a video partially or fully.

The user reaction storage 126 can be embodied as a database containing the following data for each content item output 116: content item identifier; context and type of reaction that the user had (for example speaking, listening, watching, reading, concentrating etc). Optionally, the length of the reaction and number of repetitions can also be stored. Optionally, the length of time that the user 120 takes to complete the whole content item can also be stored in the user interaction storage 126. The user reaction storage 126 may be made up of data stored in any of a variety of conventional types of digital memory including, for example, hard disk, solid state, optical disk, etc.

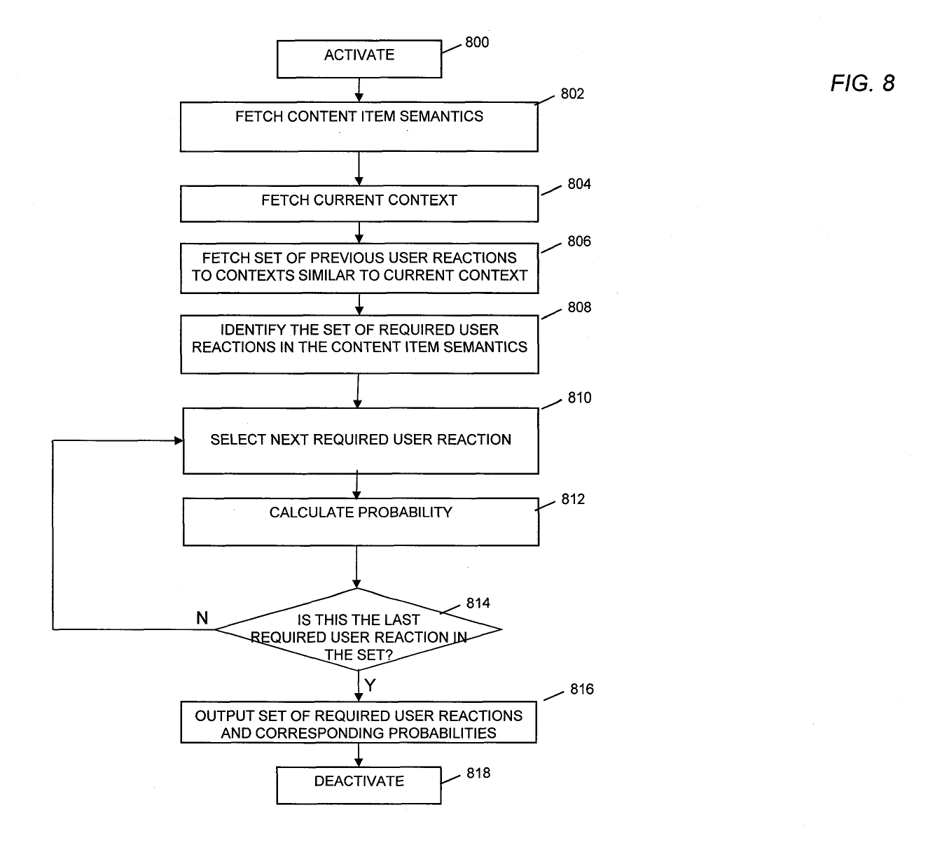

The user reaction prediction component 128 gets the current context from the user context determination component 112 and makes a prediction of how the user will react to different types of content requiring certain user reactions based on their previous user reactions as stored in the user reaction storage 126. A suggested process for predicting the user reaction is shown in the flowchart of FIG. 8, described below. The predicted user reaction is output to the content item selector 114.

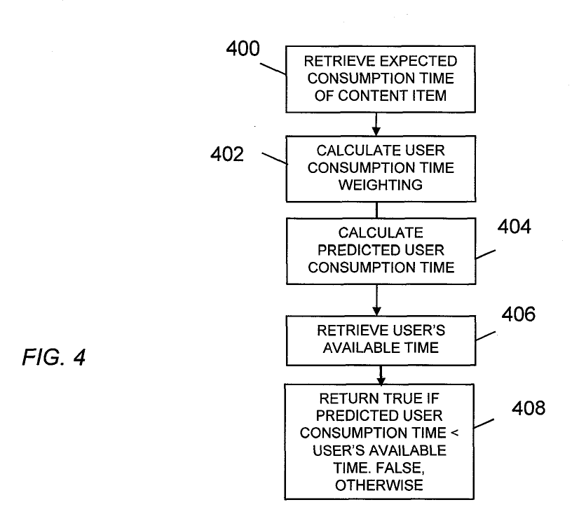

Optionally, the user reaction prediction component 128 can include in the predicted user reaction a prediction about if the user can complete the content item in the time available, based on the previous times the user took to complete similar content items as stored in the user reaction storage 126. A suggested process for predicting if the user can complete the content item in the time available is shown in the flowchart of FIG. 4, described below.

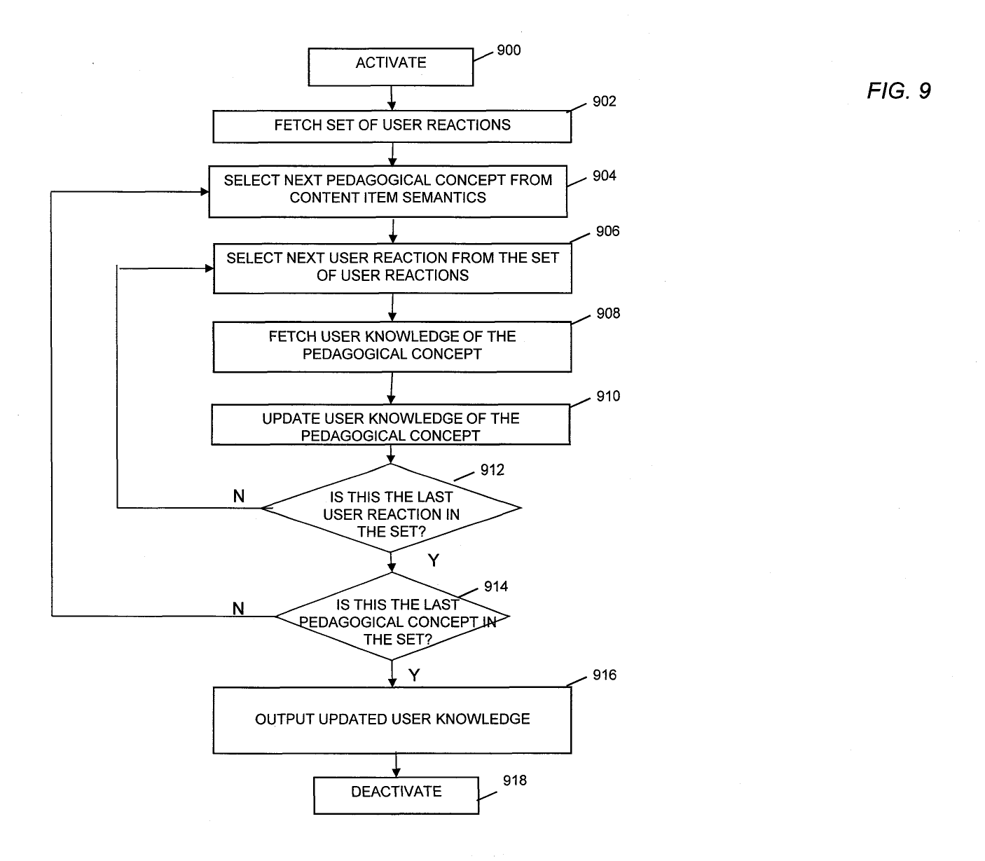

Optionally, a user knowledge update component 130 can also be included in the system. The user knowledge update component 130 updates the user knowledge model stored in the user knowledge storage 132. The user knowledge model is a model of a degree to which the user 120 knows the pedagogical concepts in the set of content items 100. The user knowledge update component 130 uses the user reactions output by the user reaction extraction component 124, including for example sufficiency, correctness and/or time duration of reaction, to update the user knowledge model using a process such as that suggested in the flowchart of FIG. 9, described below.

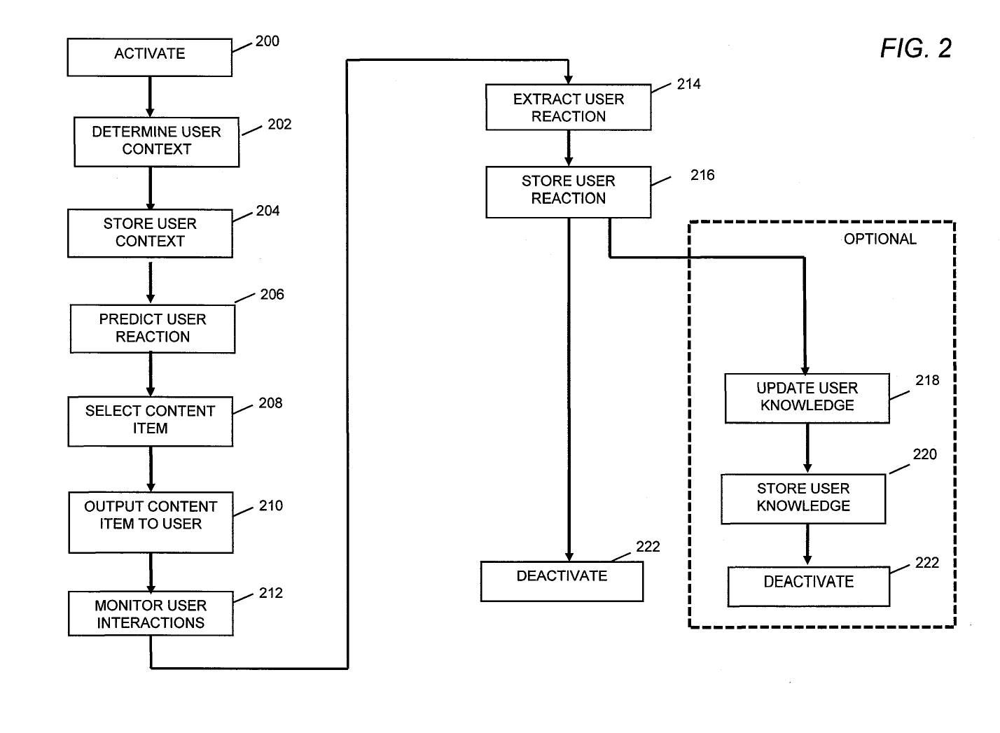

The learning content adaptation module 110 implements a method to adapt learning content as shown in the flowchart in FIG. 2. The first step 200 is activation, which can occur in a variety of ways. In an exemplary embodiment in which the system is embodied within the device 118, the user 120 manually activates the system by requesting a new content item to study by way of a touch of the screen of the device 118, a voice command, etc. The user context determination component 112 in step 202 determines the user's context, which is then stored in step 204 in the user reaction storage 126 for later predictions. In step 206 the user reaction prediction component 128 uses the current user context and previous user reactions and their corresponding user contexts from the user reaction storage 126 to predict what the current user reaction will be in the current context, using the decision making process of FIG. 8. The content item selector 114 in step 208 then selects a content item from the set of content items 100, using the decision making process of FIG. 3. In step 210 the content item selector 114 outputs the content item to the user 120 on the device 118 (e.g, via a display and/or audio speaker). In step 212 the user interaction monitor 122 monitors the user's interactions with the content item. Next, in step 214 the user reaction extraction component 124 extracts the user reaction according to the decision making process of FIG. 6. In step 216 the system stores the user reaction in the user reaction storage 126. Optional additional steps include step 218 in which the user knowledge update component 130 updates the user knowledge based on the user interactions with the content item, according to the decision making process of FIG. 9, and in step 220 stores the user knowledge in the user knowledge storage 132. In the final step 222, the learning content adaptation module 110 deactivates itself, which puts the module into a waiting state for another activation.

FIG. 3 is a flowchart of a decision making process for the content item selector 114 for selecting a learning content item, which can take place in the content item selector 114 in step 208. The first step 300 is to fetch the user identification (ID), as a different decision is calculated for each different user 120. The user ID may be obtained initially from the user using, for example, a login process in step 200 where the user is identified. Identification may be carried out by entry of a PIN, face recognition, fingerprint recognition, etc. Step 302 is to fetch a content item ID of the most recently studied content item of the set of content items 100 for the identified user, which is retrieved from the user reaction storage 126. Step 304 is to determine the ID of the next content item. Optionally, if a course structure 104 is available in the database 106, the preferred method for determining the next content item is to select the next content item in the course structure 104 which has been stored in the database 106. If the optional course structure is not available, or if the set of content items 100 are all independent and not related by a course structure, a content item is selected at random from the set of content items 100. The next step 306 is to retrieve the required user reaction for the content item which is part of the content item's semantics, as stored in the database 106. Step 308 retrieves the predicted user reaction for the content item from the user reaction prediction component 128. Step 310 is a decision point, which tests whether the predicted user reaction matches or fulfills the content item's user reaction requirements in accordance with a predetermined criteria. For example, if the content item requires the user to concentrate hard on the material, and the user is predicted not to be able to concentrate when in a noisy public location, and the user is currently in such a noisy public location, then the predicted user reaction does not match or fulfill the content item's user reaction requirements. For example, if the user is predicted to not have enough time to complete the content item in the time available, then the predicted user reaction does not match the content item's user reaction requirements (see the description of FIG. 4 below).

If there is a negative answer to decision point 310, then the process loops back to step 304 and the ID of the next content item is fetched using step 304 again. If there is a positive answer to the decision point 310, then step 312 returns the selected content item ID.

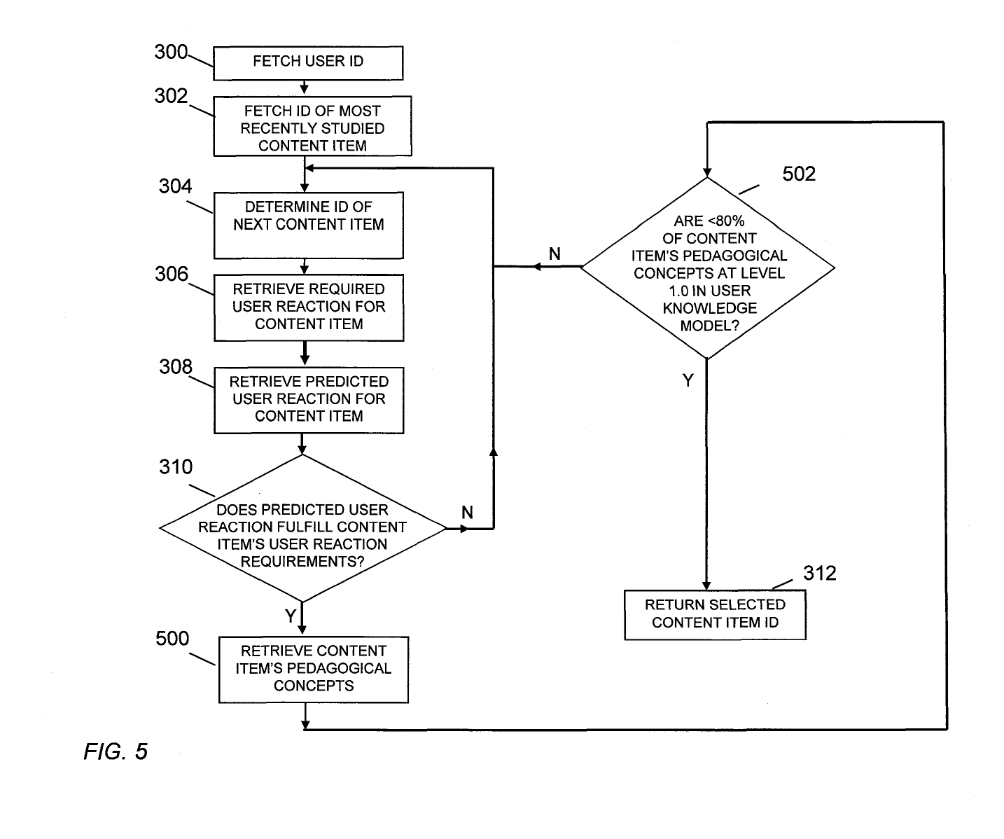

Optionally, the additional steps 500-502 shown in FIG. 5 can be included in the decision making process for selecting a learning content item. Following a positive answer in step 310, step 500 retrieves the content item's pedagogical concepts which are part of the set of content item semantics 102 from the database 106. The next step is a decision point 502 which tests whether the content item's pedagogical concepts are already known in the user knowledge model stored in the user knowledge storage 132. It is possible to choose any particular method for specifying whether a concept is known, but a preferred embodiment is to use a level between 0.0 and 1.0 which is weighted by a factor dependent on the relative importance of the mode of acquisition. If the content item's pedagogical concepts are already known in the user knowledge model, then the process loops back to step 304. It is possible to choose any particular method for specifying whether the whole set of pedagogical concepts in the content item are known well enough to no longer need further study, but a preferred embodiment would be to consider the set to be well known enough when 80% of the content item's pedagogical concepts are at a level 1.0. If the decision made at decision point 502 is that the pedagogical concepts are not already known, then the final step 312 of the decision making process is to return the content item ID.

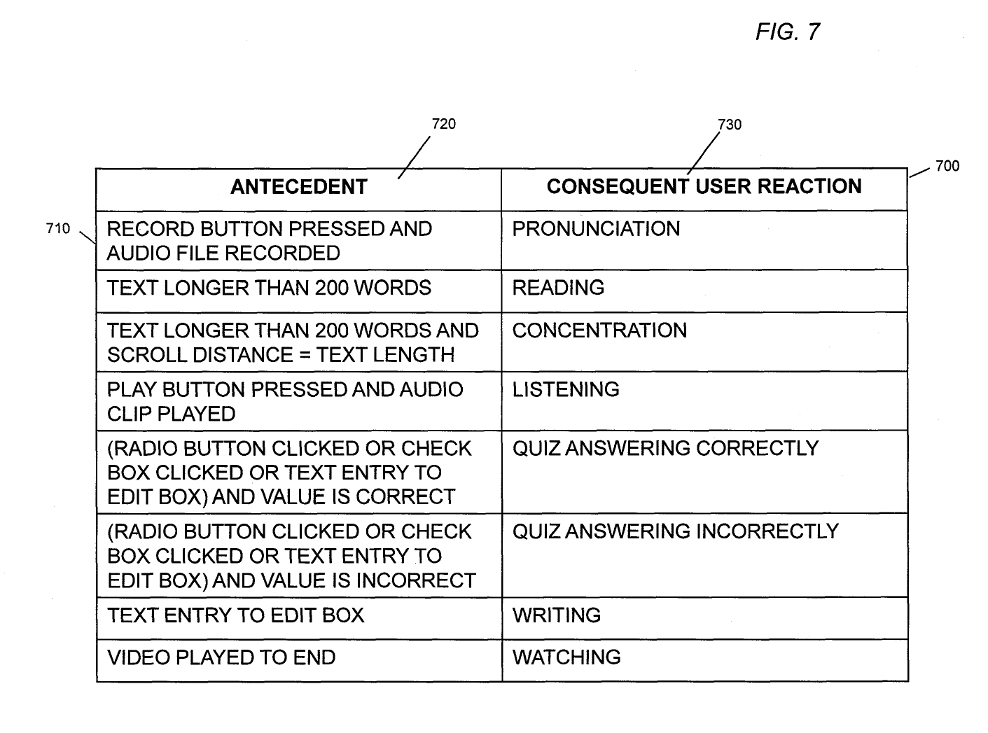

FIGS. 6 and 7 show a preferred embodiment of a decision making process of the user reaction extraction component 124 for extracting a set of user reactions from a set of user interactions with a content item. The preferred set of user reactions to extract are Pronunciation, Listening, Writing, Quiz Answering Correctly, Quiz Answering Incorrectly, Watching a Video, Concentration and Reading, but other user reactions could additionally be extracted by including additional rules in the rulebase of the decision making process. The decision making process of FIG. 6 is activated 600 when the user interaction monitor 122 monitors a new set of user interactions between the user 120 and the content item output 116. Step 602 selects the next rule 710 in a rulebase 700. The rule can be selected sequentially or by any other preferred method. A decision point 604 tests whether the conditions on the set of user interactions and content item satisfy the rule antecedent 720. If the answer is “Yes”, then the rule consequent 730 is added to the set of user reactions in step 606. If the answer to the decision point 604 is “No” then step 606 is skipped. Step 608 is a second decision point, which tests whether there are more rules in the rulebase that have not yet been applied. If so, the decision process loops back to step 602 to select the next rule in the rulebase. If there are no more rules in the rulebase, then step 610 outputs the set of user reactions, and finally step 612 deactivates the process. The user reactions are then stored in the user reaction storage 126 and subsequently utilized to predict user reaction and to update the user knowledge model in the user knowledge storage 132, for example.

Optionally, the total time to complete all the user interactions in the content item can be also output as a user reaction to the content item in step 610. This user reaction information may also be stored in the user reaction storage 126 and subsequently utilized to predict user reaction and to update the user knowledge model in the user knowledge storage 132 (e.g., for purposes of determining the user consumption time weighting). Optionally, instead of a user reaction being associated with the whole content item, a user reaction can be associated with a pedagogical concept in the content item. Additional rules can be added to the rulebase to extract this more detailed information.

FIG. 7 shows a table 700 representing an embodiment of the rulebase to extract a set of user reactions from a set of user interactions. The rulebase includes a set of if-then rules with a rule 710 comprising an antecedent 720 “Record button pressed and audio file recorded” and a consequent user reaction 730 of “Pronunciation”. Additional rules can be added to this rulebase.

FIG. 8 shows a flowchart of a preferred embodiment of a decision making process for predicting a user reaction to a content item, which takes place in the user reaction prediction component 128. The decision making process for predicting user reaction to a content item is activated in step 800. Step 802 fetches the content item semantics of the content item from the content item selector 114, which includes a set of required user reactions. Step 804 fetches the current context from the user context determination component 112. Step 806 fetches the set of previous user reactions to any context that is similar to the current context from the user reaction storage 126. Any known method can be used to assess the similarity between contexts, but a preferred embodiment is pairwise comparison between each parameter in the two contexts C1 and C2 with n parameters, as shown in the following equation:

$$Similarity ( C 1 , C 2 ) = {\sum }_{i = 0}^{i = n} normalize ( \{ \begin{matrix}Levenshtein distance ( C 1. i , C 2. i ) , & if value of i is a string \\ \vert C 1. i - C 2. i \vert , & if value of i is numeric\end{matrix} \} )$$

At a minimum, the Levenshtein distance between the string values of the location parameters of the two contexts can be used to assess similarity. If the values are numeric, such as the values of the available time parameter of the context, a numeric difference can be calculated. Device capabilities can also be included. For example, if a microphone is present in both contexts a value of 1 is used. If a microphone is available in one context, but not the other then a value of 0 is used. More generally, a comparison of how similar are two devices can be calculated from the device profiles. If more than one context parameter is included in the similarity measurement, the individual contributions from each parameter in the context can be normalised before summation.

Step 808 is to identify the set of required user reactions in the content item semantics of the content item. Each required user reaction is of a certain type, for example in a language learning application, a user reaction may be a Pronunciation type, or a Writing type. Each of these required user reactions is processed in turn, so the next step, 810, selects the next required user reaction from the set of required user reactions. Step 812 calculates the probability of the user making the required user reaction (of type i) given the current context using the following equation:

$$Probability ( required user reaction of type i \text{\textbar} current context ) = \frac{\begin{matrix}Number of previous user reactions \\ of type i in similar contexts\end{matrix}}{\begin{matrix}Total required user reactions of \\ type i in similar contexts\end{matrix}}$$

If there are an insufficient number of previous user reactions in the user reaction storage 126 to make the above calculation, then the system can fall back to using pre-determined (default) probability values. Optionally, the pre-determined values can be mixed with the probabilities calculated as above. For example, if the context is a busy or noisy location, the probability of a user reaction of type concentration can be pre-determined as 0.1, of a user reaction of type reading can be pre-determined as 0.3, and so on. For example, if the device has no microphone, then the probability of a user reaction of type speaking is 0.0. Any means can be used to store the pre-determined probabilities, for example, a table.

Step 814 is a decision point. If the required user reaction is not the last one in the set of required user reactions, the process loops back to step 810 and selects the next required user reaction from the set of required user reactions. If it is the last required user reaction in the set, then step 816 takes place and the set of required user reactions and their corresponding probabilities are output. Finally, step 818 deactivates the process.

FIG. 4 shows a flowchart of a preferred embodiment of a decision making process for predicting a user reaction to a content item, in particular if the user can complete the content item in the time available, which takes place in the user reaction prediction component 128. Step 400 retrieves the expected consumption time for a default user of the content item, which is an optional part of the content item's semantics. Step 402 calculates the user consumption time weighting. The user consumption time weighting is the average over the history of user reactions to similar content items of the ratio of the user's actual consumption time to the consumption time of a default user on the same content item. The weighting can be calculated as follows:

$$weighting = \frac{{\sum }_{c ∈ S}^{size of ( S )} \frac{user consumption time of c}{expected consumption time for a default user of c}}{size of ( S )}$$

where S is a set of content items similar to the current content item (for example, of the same type) presented in similar contexts. For example, if the user is always 20% slower than a default user, the weighting would be 1.2.

Step 404 calculates the predicted user consumption time. The predicted user consumption time is the product of the user consumption time weighting and the expected consumption time for a default user. Step 406 retrieves the user's available time, which is output as part of the user context from the user context determination component 112. Step 408 returns true if the user's predicted consumption time for the content item is less than the user's available time (more generally, whether the reaction of the user required by the content item matches the user's predicted reaction in accordance with a predetermined criteria).

The system to select a learning content item can optionally include user knowledge in the selection of a content item. FIG. 9 shows a flowchart of a preferred embodiment of a decision making process carried out in the user knowledge update component 130 for updating the user knowledge model in the user knowledge storage 132. Step 900 activates the process. Step 902 fetches the set of user reactions to the current content item output 116 from the user reaction extraction component 124. Steps 904 to 914 are repeated for each pedagogical concept in the set of pedagogical concepts. Step 904 selects the next pedagogical concept from the content item semantics. Steps 906 to 912 are repeated for each user reaction in the set of user reactions for each pedagogical concept. Step 906 selects the next user reaction. Step 908 fetches the user knowledge of the pedagogical concept from the user knowledge storage 132. The user knowledge of a pedagogical concept is represented as a measure of how well the user knows the concept. A preferred measurement is a value between 0.0 and 1.0, which is incremented by the following amounts, depending on what type of user reaction has occurred:

| Type of User Reaction | User Knowledge Increment |
|---|---|
| Pronunciation | 0.2 |
| Listening | 0.01 |
| Writing | 0.25 |
| Quiz Answering Correctly | 0.25 |
| Quiz Answering Incorrectly | 0.2 |
| Watching a Video | 0.01 |
| Concentration | 0.0 |
| Reading | 0.05 |

These preferred increments reflect the relative impact that each type of user reaction has in increasing user knowledge. Concentration as an independent user reaction does not increment the user knowledge in the preferred embodiment, as it is only considered to improve knowledge when manifest in other more measurable reactions, such as quiz answering.

Step 910 updates the user knowledge model of the pedagogical concept with the corresponding increment according to the type of user reaction. Step 912 is a decision point, which loops the process back to step 906 if there are other user reactions in the set, so that the user knowledge can be further incremented according to all the types of user reaction to that pedagogical concept. Step 914 is a decision point which loops the process back to step 904 if there are further pedagogical concepts to process. If the process has reached the last pedagogical concept in the set, then step 916 outputs the updated measures of user knowledge for the set of pedagogical concepts to the user knowledge storage 132. Finally, the process is deactivated in step 918.

Optionally, the user reaction extraction component can assign a user reaction to a specific pedagogical concept, so that the user knowledge update calculation is assigned different weightings per pedagogical concept, per presentation of the pedagogical concept in the content item (as a pedagogical concept may appear more than once in the same content item) and per user reaction type.

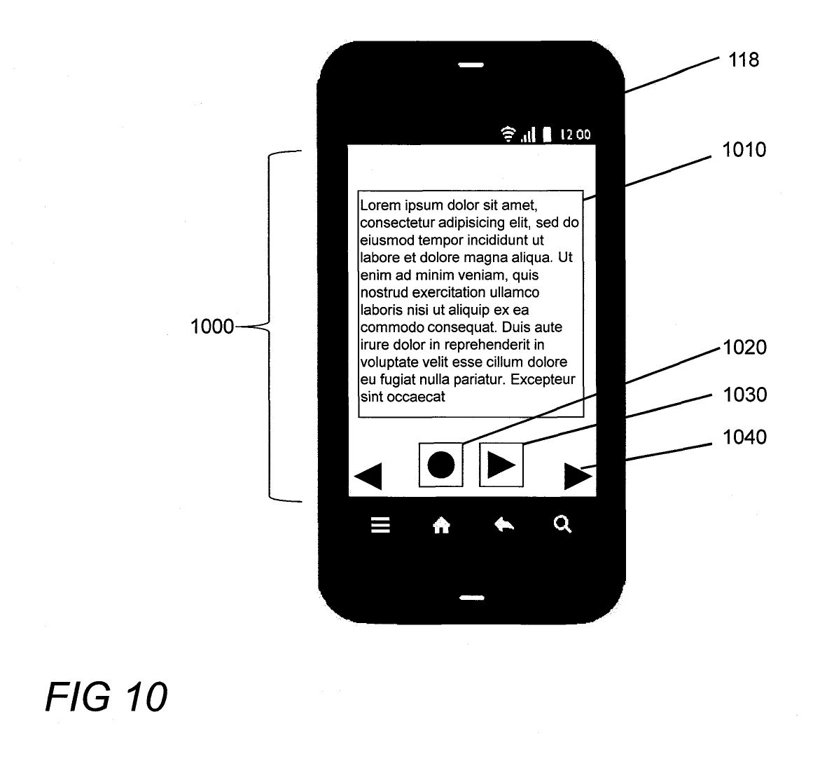

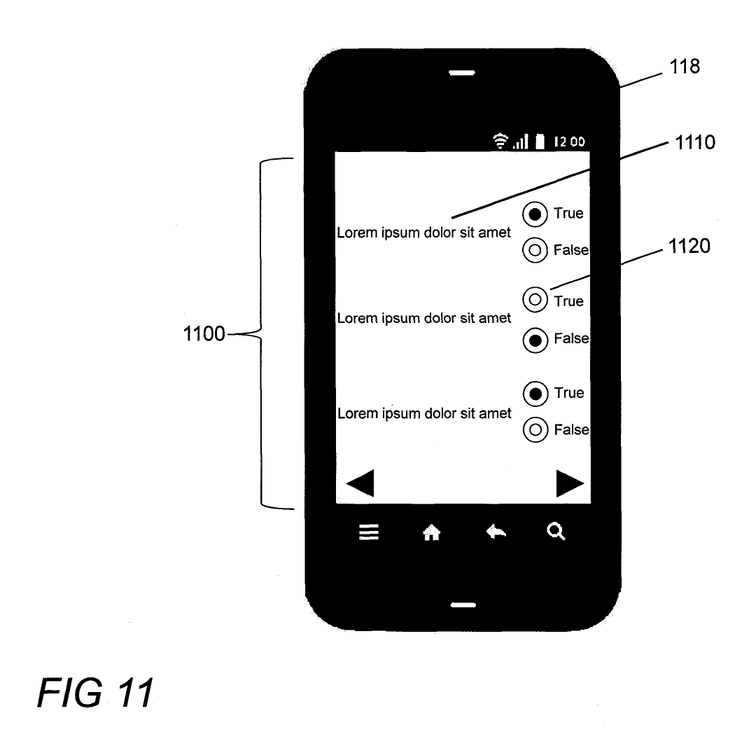

FIG. 10 shows the front view of a device 118 on which the system to adapt learning content based on predicted user reaction can be implemented. The device 118 shown in FIG. 10 is a smart phone, but any other computing device such as a personal computer, tablet, television, or interactive whiteboard could also be used. The content item 1000 displayed on the device in FIG. 10 includes an example of detailed text 1010 that requires a user reaction of deep concentration in order to study, and the record button 1020 and audio playback button 1030 indicate required user reactions of speaking and listening respectively. When the Next button 1040 is pressed, the content item selector 114 is activated and a new content item from the set of content items 100 is selected from the database 106 and output to the user 120 on their device 118. In this way, the user can step through a number of content items which have been selected according to the individual user's context and previous user reactions to the content. For example, when the Next button 1040 is pressed, the content item selector 114 may select a new content item 1100 as depicted in FIG. 11. The content item 1100 shown on the device 118 in FIG. 11 is an example of a content item which might be selected when a user has less time available or is in a context which precludes concentration or speaking out loud. The content item 1100 includes simple text 1110 and simple input 1120 which could be for example via radio button input, together making up a true/false quiz activity which requires a user reaction of reading the text and little required concentration in order to answer the quiz questions.

FIG. 12 shows a preferred embodiment of a system to automatically extract content item semantics from a set of content items 100. A digital processor 1200 includes a non-transitory machine readable memory 1202 storing a program therein which, when executed by the digital processor 1200, carries out the various functions described herein. The memory 1202 may be the same memory 134 or separate memory, and may also serve to store data as referred to herein. One having ordinary skill in the art of programming will be enabled to provide such a program using conventional programming techniques so as to cause the digital processor 1200 to carry out the described functions. Accordingly, further detail as to the specific programming code has been omitted for sake of brevity. The digital processor 1200 contains a content item semantics extraction module 1210 that extracts semantics from one or more of the set of content items 100 and stores the semantics in a database 106. The content item semantics extraction module 1210 contains at least a required user reaction extraction component 1220. The required user reaction extraction component 1220 extracts one or more user reactions that are required by an item from the set of content items 100. It is understood that someone skilled in the art could select an appropriate extraction method to identify one or more of a number of required user reactions for use within the required user reaction extraction component 1220. An exemplary method for extracting required user reaction identifies user interface elements in the set of content items 100 such as record buttons to indicate that speaking is a required user reaction, or long edit boxes to indicate that detailed writing is a required user reaction, or an exemplary extraction method identifies content assets like audio to indicate that listening is a required user reaction. An exemplary extraction method can also include a measure of the length of text to indicate that concentration while reading is a required user reaction.

Optionally, the content item semantics extraction module 1210 may contain one or more of a pedagogical concepts extraction component 1230 or an expected consumption time extraction component 1240. The pedagogical concepts extraction component 1230 extracts one or more pedagogical concepts that are being taught by an item within the set of content items 100. It is understood that someone skilled in the art could select an appropriate extraction method to identify one or more of a number of pedagogical concepts that are being taught by the content item. An exemplary pedagogical concepts extraction method that applies to the language learning domain identifies one or more of vocabulary concepts or grammar concepts, which are types of pedagogical concepts. An exemplary pedagogical concepts extraction method performs an analysis of the parts of speech in the text, video captions or audio converted to text using a speech-to-text synthesizer from a content item in the set of content items 100. Each lemma output by the parts of speech analysis can be identified as a vocabulary concept. Each sentence of text can be run through a grammar parser to identify one or more grammar concepts.

The expected consumption time extraction component 1240 can employ any well-known method for extracting the expected consumption time of a content item from the set of content items 100. An exemplary embodiment of the expected consumption time extraction component 1240 derives times empirically from experimental data evaluating users trialing example content items. An alternative embodiment that can be employed if no experimental data is available calculates the expected consumption time using the run time of any media within the content item multiplied by a weighting factor that can relate to the number of recommended or expected repetitions of the medium. For example, if the content item contains a video, and it is pedagogically recommended that the user watch the video twice, then the expected consumption time of the content item can be calculated as twice the time taken to watch the video. An advantage of the present invention is that it may predict the individual user's expected consumption time based on previous user interactions, so even if the expected consumption time extraction component 1240 produces a very poor estimate of expected consumption time for an average user, the accuracy for the individual user will be higher.

FIG. 13 shows an exemplary embodiment of a graph structure of content items and content item semantics which can be stored in the database 106. The graph node 1300 represents a content item, and the properties 1310 of the node contain the multimedia that go to make up the content item. Every content item node has an ID, and then for example, one or more of the following properties could be used: title text, instructions text, question text, correct answer text, score text, image, video, and audio. Other text can also be stored as a content item node property, for example lists of vocabulary or grammar items. Optionally, a content item node 1300 can have a content item semantics, which are stored in a content item semantics node 1330 in the graph. The content item node is linked to the corresponding content item semantics node 1330 by a graph link 1320 for example “has_semantics”. The content item semantics node 1330 has a set of properties 1340 including an ID and a required user reaction. Optionally, properties can also include a set of pedagogical concepts that are being taught by the content item, and an expected consumption time of the content item. An optional course structure can be represented by the course structure links 1350, which includes directional links such as “followed_by” or “has_prerequisite”. The content item 1300 can be linked to a second content item 1360 by a course structure link 1350.

The invention can be applied to educational domains other than language learning, by including other pedagogical concepts or user reactions appropriate to the domain. For example, in a language learning application, the pedagogical concepts could be vocabulary or grammar rules, while in a mathematics application, the pedagogical concepts could be topics like complex numbers, addition, multiplication and so on. In a language learning application, types of user reaction such as reading, listening and pronunciation are important, whereas in another educational domain the invention could include other types of user reaction such as calculation, recall and concept understanding. Additional rules could be included in the rulebase of FIG. 6 to enable extraction of these user reactions from the set of user interactions.

The invention as described herein includes not only the educational system, but also a computer program and method as described herein for implementing such a system.

The present invention has one or more of the following advantages.

An advantage of the system is that the system selects a learning content item according to the individual user's predicted reaction to the learning content item, given a context of use, and updates its prediction over time. This means that learning content items appropriate to the user's context are presented to the user.

An advantage of the system is that it adapts to the individual user's speed of study, and updates its prediction over time. This is particularly useful as it is well known that students take widely differing times to complete self-study courses.

An advantage of the system is that it enables the user to cover the set of content items in a shorter time, thus allowing more efficient learning, as it is less likely that the user is presented with a content item that is too long for the remainder of their study session. A learning content item that has not been finished by the user by the end of the study session results in some loss of time at the start of the next study session, as the user may have forgotten how far they had progressed through the item, or need to review what they had achieved so far. The present invention reduces the likelihood of this occurring. This advantage is particularly important in the mobile context, where study sessions are known to be short and frequently interrupted.

A further advantage of the system is that user motivation is increased as they have the satisfaction of completing more learning content items, rather than continually being left with half-finished learning content items at the end of their study session.

User motivation is also increased because they are less likely to be presented with tasks that they cannot complete due to their location, for example they are less likely to be asked to practice pronunciation on the train, the user will not be demotivated by having to skip tasks, embarrassed that they have to complete the task, or stressed by the cognitive overload of trying to concentrate to fulfill a complex task in a noisy environment.

Another advantage of the system arises since the user is less likely to skip skill training such as pronunciation practice, as they are presented with those content items when their context of use is appropriate and they are prepared to practice the skills. This means that the user receives a balanced training in all the core language learning skills (reading, writing, speaking, listening), and are exposed to a wider range of content types, which is more interesting for them.

A further advantage is that the user knowledge model and user interaction model can be accessed and updated by external systems such as review systems, test systems, question-and-answer systems, operator's interfaces, learning management systems, e-learning systems, and so on. Thus the system can form part of a comprehensive language learning platform.

A further advantage is that the system can be implemented as an integrated apparatus or split between a separate learning content interface and an adaptive learning component that are coupled together.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

This invention can be applied to any set of learning content items being studied ubiquitously, where different items require different reactions from the learner, such as an educational course. One example would be its use in a multimedia language learning course delivered to mobile devices, which could be studied by students in different mobile contexts.

1. An educational system, comprising:
a database which stores a set of distinct multimedia learning content items and content item semantics which identify a reaction of a user required by a corresponding content item in the set of content items;
a digital processor which includes:
a user context determination component configured to determine a context in which the user is using the system;
a user reaction storage configured to store a history of previous reactions of the user to content items within the set of content items and the contexts in which the user interacted with the content items;
a user reaction prediction component configured to predict how the user will react with respect to different types of user reactions required by the content items based on the context determined by the user context determination component and on the history of previous user reactions to the content items and the contexts in which the user interacted with the content items stored in the user reaction storage; and
a content item selector configured to select at least one content item from the database so that the reaction of the user required by the at least one content item matches according to a predetermined criteria the prediction of how the user will react to the type of user reaction required by the at least one content item; and
a content item output which presents the selected at least one content item to the user.

2. The educational system according to claim 1, wherein:
the set of content item semantics include an expected consumption time of the corresponding content item for a default user;
the user reaction prediction component is configured to predict a consumption time of the corresponding content item for the user; and
the content item selector is configured to select the at least one content item based on the expected consumption time and the predicted consumption time.

3. The educational system according to claim 1, the digital processor including a user knowledge storage component which stores a user knowledge model representing a degree to which the user knows pedagogical concepts in the set of content items, and wherein the content item selector is configured to select the at least one content item based on the user knowledge model.

4. The educational system according to claim 3, the digital processor further including a user knowledge update component configured to update the user knowledge model based on user reactions to content items within the set of content items which have been presented to the user.

5. The educational system according to claim 4, wherein the user knowledge update component is configured to update the user knowledge model based on a time duration of reactions of the user to content items within the set of content items which have been presented to the user.

6. The educational system according to claim 4, wherein the user knowledge update component is configured to update the user knowledge model based on at least one of a sufficiency and correctness of reactions of the user to content items within the set of content items which have been presented to the user.

7. The educational system according claim 1, the digital processor further including a user interaction monitor configured to monitor interactions of the user with the selected at least one content item presented to the user.

8. The educational system according to claim 7, the digital processor further including a user reaction extraction component configured to extract the user reaction to the at least one content item presented to the user from the interactions monitored by the user interaction monitor.

9. The educational system according to claim 8, wherein the user reaction extraction component comprises a rulebase including rules which are applied to interactions monitored by the user interaction monitor, and user reactions are extracted based on whether the rules are satisfied.

10. The educational system according to claim 1, wherein the extracted user reaction is used to update the history stored in the user reaction storage.

11. The educational system according to claim 1, wherein a context of the user determined by the user context determination component includes a location of the user insofar as a type of place where the user is located.

12. The educational system according to claim 1, wherein a context of the user determined by the user context determination component includes an amount of study time available to the user.

13. The educational system according to claim 1, wherein a context of the user determined by the user context determination component includes capabilities of a user device included in the system.

14. The educational system according to claim 1, wherein the content item selector is configured to identify a next content item in accordance with a course structure stored in the database.

15. The educational system according to claim 1, wherein the user reaction prediction component is configured to predict how the user will react to a given content item by fetching the content item semantics corresponding to the given content item, fetching a current context of the user as determined by the user context determination component, fetching previous user reactions to contexts similar to the current context from the user reaction storage, identifying the required user reaction to the given content item from the corresponding content item semantics, and determining the probability of the user making the required user reaction to the given content item based on the previous user reactions to contexts similar to the current context.

16. The educational system according to claim 15, wherein in the event there is an insufficient number of previous user reactions available from the user reaction storage, the user reaction prediction component is configured to at least one of (i) use pre-determined probability values to determine the probability of the user making the required user reaction; and (ii) use the pre-determined probability values in combination with the previous user reactions available from the user reaction storage.

17. The educational system according to claim 1, wherein the different types of user reactions required by the set of content items include two or more of pronunciation, reading, concentration, listening, remembering, response to quiz, writing and watching.

18. The educational system according to claim 1, wherein the educational system is embodied within at least one of a smart phone, tablet, personal computer, notebook computer, television, interactive whiteboard.

19. A method to adapt learning content based on predicted user reaction, comprising:
providing a database which stores a set of distinct multimedia learning content items and content item semantics which identify a reaction of a user required by a corresponding content item in the set of content items;
utilizing a digital processor to provide:
a user context determination component configured to determine a context in which the user is using the system;
a user reaction storage configured to store a history of previous reactions of the user to content items within the set of content items and the contexts in which the user interacted with the content items;
a user reaction prediction component configured to predict how the user will react with respect to different types of user reactions required by the content items based on the context determined by the user context determination component and on the history of previous user reactions to the content items and the contexts in which the user interacted with the content items stored in the user reaction storage; and
a content item selector configured to select at least one content item from the database so that the reaction of the user required by the at least one content item matches according to a predetermined criteria the prediction of how the user will react to the type of user reaction required by the at least one content item; and
presenting the selected at least one content item to the user.

20. A non-transitory computer readable medium having stored thereon a program which when executed by a digital processor in relation to a database which stores a set of distinct multimedia learning content items and content item semantics which identify a reaction of a user required by a corresponding content item in the set of content items, carries out the process of:
determining a context in which the user is using the system;
storing a history of previous reactions of the user to content items within the set of content items and the contexts in which the user interacted with the content items;
predicting how the user will react with respect to different types of user reactions required by the content items based on the determined context and on the stored history of previous user reactions to the content items and the contexts in which the user interacted with the content items;
selecting at least one content item from the database so that the reaction of the user required by the at least one content item matches according to a predetermined criteria the prediction of how the user will react to the type of user reaction required by the at least one content item; and
presenting the selected at least one content item to the user.
